(19) United States
(12) Patent Application Publication
(10) Pub. No.: US 2003/0054887 A1
(43) Pub. Date: Mar. 20, 2003

(54) System for presenting table game limits and related information

(76) Inventors: Craig Dettrey, Blackwood, NJ (US); Frank Uzzolino, Holland, PA (US); Clifton G. Blase, Westerly, RI (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/195,061

(22) Filed: Jul. 15, 2002

Related U.S. Application Data
(60) Provisional application No. 60/322,744, filed on Sep. 18, 2001.

(51) Int. Cl. A63F 13/00

(52) U.S. Cl. 463/42

(57) ABSTRACT

To help, for example, casino's move further into the hi-tech world of computer controlled gaming, casino managers, with the aid of this device, can control advertised gaming limits and/or promotions for any table located within the establishment. The device can be controlled from a central location, a handheld device and/or can operate as a standalone system. The preferred embodiments include an electronic, computer-controlled system capable of presenting minimum and maximum table game limits, as well as informational messages to casino players. The preferred embodiments also relate to a central controlling computer system and an associated satellite system.

The present application claims priority to U.S. Provisional Application Serial No. 60/322,744, filed on September 18, 2001, for System for Presenting Table Game Limits and Related Information (Dettrey et al.), the entire diclosure of which is incorporated herein by reference as though recited herein in full.

### BACKGROUND OF THE INVENTION

The preferred embodiments of the present invention relate to an electronic, computer-controlled system capable of presenting, in some illustrative examples, minimum and maximum table game limits, as well as informational messages to casino players. The preferred embodiments also relate to a central controlling computer system and associated supporting systems related thereto.

### DESCRIPTION OF THE ART

Traditionally, on casino host table games such as Blackjack and Roulette, casino customers, “players,” spend hours upon hours enjoying these games in the hopes of “hitting it big” and winning large sums of money. The amount of money a player may wager at any given time is governed by several factors including volume of players, time of day, and other casino policies.

Managers typically convey a table's minimum and maximum bets via cardboard or plastic signs. These signs contain imprinted numeric dollar amounts indicating the minimum and maximum bets allowed at that point in time. A sign is placed on or near the gaming table in a place clearly visible to all players. When it comes time to change the minimum or maximum bets for a table or a set of tables, managers walk from table to table, removing the old signs and replacing them with a different sign depicting the new table limits.

There are inherent problems with the above described system. For example, signs become damaged and misplaced. With all of the potential misuse, the lifespan of a sign is a relatively short period of time.

### SUMMARY OF THE PREFERRED EMBODIMENTS

The preferred embodiments described herein can be used to eliminate the problems with existing systems, while adding automation and other timesaving and management features to casinos and/or other commercial establishments.

In preferred embodiments, messaging display client devices are provided that are ultimately connected to a controlling server. The client devices preferably present the current minimum and/or maximum table limits in effect at the gaming table at any given point in time. Preferably, a combination of static and/or animated messages can also be displayed. Preferably, the server synchronizes the client devices and collects table information from each table.

In preferred embodiments, the system includes some or all of three major components: Master Client Devices (MCD); Satellite Client Devices (SCD); and a Central PC Server (CPCS). Each Master Client Device is preferably capable of displaying three pieces of information that reside either natively on the MCD, or that is provided from the Central PC Server via a communications protocol. Game managers can configure current selections via a button interface. Preferably, alerts from the CPCS are visible via a lamp array.

Minimum and maximum bets are preferably conveyed to the players via character display devices. Preferably, a plurality of lines (e.g., two or so) of informational messages, such as a table reserved status, a table open status, a table closed status, a nonsmoking status and/or current promotions, can be presented in either a stationary or an animated fashion. Preferably, the character displays are of a sufficient height to permit potential players to read the settings from a distance, while not being large enough to make the overall device or enclosure overly obtrusive.

In some embodiments, game managers preferably modify current minimum, maximum and message settings by pressing combinations of buttons located, for example, on the enclosure. In preferred embodiments, three buttons are used. This method allows for standalone Master Client Devices. In embodiments using a networked environment, such changes are preferably relayed back to the Central PC Server. In some preferred embodiments, a remote interface, such as an infrared interface (IrDA) can also be used to permit changes to the sign's value via a handheld device or computer also equipped with a similar (e.g., IrDA) interface.

Preferably, alerts from the CPCS Manager notify game managers of predetermined conditions or situations by toggling and/or flashing a sequence of status lamps located on the system's enclosure. In preferred embodiments, between the buttons and the alert lamps, simple communications between the game managers and the CPCS manager can be achieved.

In situations where the MCD is located in a configuration making it impossible for the game manager to manipulate the buttons, a smaller device, an SCD, may be located within reach and visible to the game manager. The SCDs may also contain buttons, status lamps, and a character display device to present vital information back to the game manager.

In some preferred embodiments of the invention, the MCD stands isolated. In these embodiments, each MCD is preferably independently and manually controlled by the acts of either a game manager via buttons or the like and/or by the acts of a roaming administrator equipped with a handheld computing device. Preferably, the roaming administrator needs at most only to point to the handheld device at the MCD for changes to take effect. For smaller casinos not wishing to invest in the CPCS network, these embodiments of the invention are highly suitable. In other preferred embodiments of the invention, multiple MCDs exist as part of a network of MCDs centrally connected to a CPCS via a network. Preferably, a single CPCS centrally, and simultaneously, administers minimums, maximums and/or messages for a multitude of MCD devices. Preferably, the CPCS also receives communications back from the MCD. Preferably, within the CPCS exists a user-interface permitting CPCS administrators to easily control a multitude of MCD devices. Preferably, the user-interface is customized to suit the particular establishment's table configuration.

According to some embodiments, a method of presenting gaming information to at least one casino gaming player at a gaming table includes: providing a casino gaming table; locating a client device proximate the at least one table; inputting gaming information into the client device; and displaying at least some of the gaming information via a display connected to the client device.

According to other embodiments, a casino computer system is provided that includes: a) at least one gaming table; b) at least one client device proximate the gaming table; c) at least one input device for inputting gaming information into the client device; and d) a display device for displaying the gaming information to gaming players.

According to other embodiments, a gaming computer system is provided that includes: a) a plurality of client devices including respective displays; b) said displays of the client devices being located proximate respective gaming tables; and c) at least one user-interface for inputting information that is displayed on the displays.

According to other embodiments, a process for producing a gaming-system product including a gaming information display proximate a gaming table includes: providing a gaming table; locating a client device proximate the table; inputting gaming information into said client device; and displaying at least some of the gaming information via a display connected to the client device, further including displaying as part of the gaming information minimum or maximum table bets and promotional information.

The above and other advantages, features and/or benefits of various embodiments and the above and other embodiments of the invention will be further appreciated upon review of the following description of preferred embodiments of the invention, along with the accompanying illustrative Figures. Various other embodiments, aspects, advantages and/or benefits of various embodiments of the present invention will be appreciated based on the present disclosure. It is contemplated that various embodiments will include and/or exclude different aspects, advantages and/or benefits and that descriptions of aspects, advantages and/or benefits of the various embodiments should not be construed as limiting other embodiments nor the inventions claimed.

### BRIEF DESCRIPTION OF THE DRAWINGS

The preferred embodiments are shown by way of example and not limitation in the attached figures, in which:

FIG. 1 is a block diagram of a Master Client Device illustrating the major hardware components of said device, according to some preferred embodiments;

FIG. 2 is an illustration of how multiple Master Client Devices may be connected through a typical network to a Central PC Controller, according to some preferred embodiments;

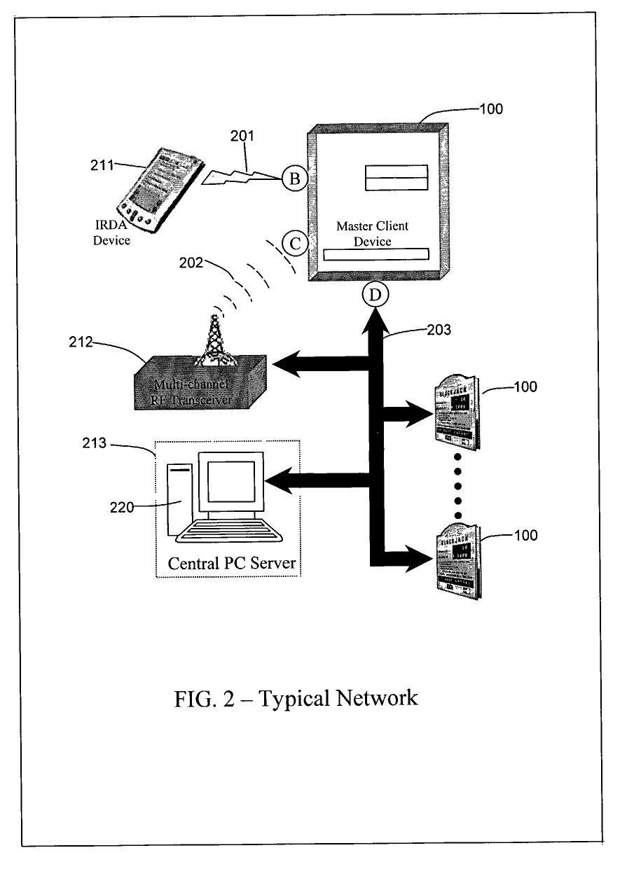

FIG. 3 is a block diagram of a Satellite Client Device illustrating the major hardware components of said device, according to some preferred embodiments;

FIG. 4 is a flowchart illustrating the software Power-Up Sequence, according to some preferred embodiments;

FIG. 5 is a flowchart of the Main Loop of the software, according to some preferred embodiments;

FIG. 6 is a flowchart illustrating the steps the CCU software goes through to identify a command, according to some preferred embodiments;

FIG. 7 is a flowchart illustrating the steps the CCU software goes through to process a command, according to some preferred embodiments;

FIG. 8A is a front perspective view of an illustrative embodiment of a casino sign, according to an illustrative embodiment of the invention, and FIG. 8B is a front view of another illustrative embodiment of a sign, according to another illustrative embodiment of the invention;

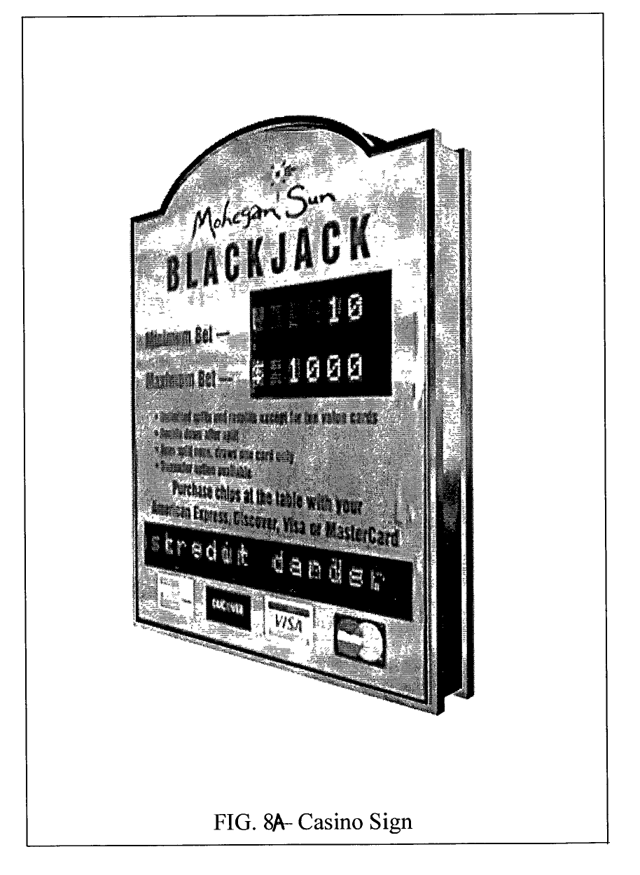

FIG. 9 is the flowchart illustrating the steps the CCU software executes to animate the messages display with various effects, according to some preferred embodiments;

FIG. 10 is a flowchart illustrating the steps the CCU software executes to query the state of the buttons located on the MCD, according to some preferred embodiments;

FIG. 11 is a state diagram illustrating the operation and various states of the State Machine as the user attempts to change the Minimum value, according to some preferred embodiments;

FIG. 12 is a state diagram illustrating the operation and various states of the State Machine as the user attempts to change the Maximum value, according to some preferred embodiments;

FIG. 13 is a state diagram illustrating the operation and various states of the State Machine as the user attempts to change the animated Message, according to some preferred embodiments;

FIG. 14 is a flowchart illustrating the steps the CCU software executes during a hardware interrupt, according to some preferred embodiments;

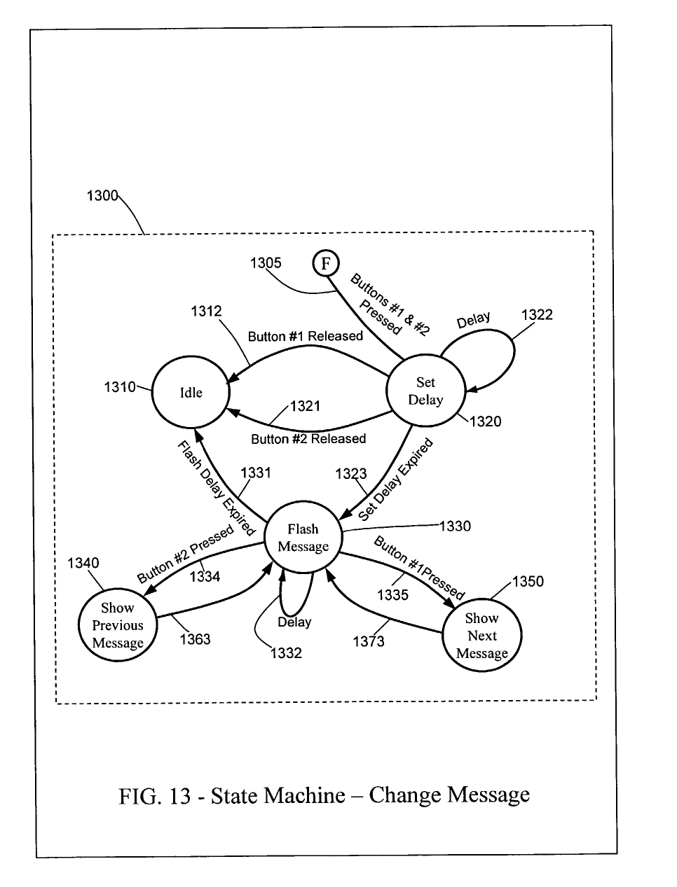

FIG. 15 shows persistent memory in an onboard non-volatile memory, according to some preferred embodiments;

FIG. 16 describes the format of the Request Message, that is the message originating on the Central PC Controller and whose destination is a single or plurality of MCDs, according to some preferred embodiments;

FIG. 17 describes the format of the Response Message, that is the message originating on the MCD in reply to a Request Message, according to some preferred embodiments (the destination of a Response Message is the Central PC Controller);

FIG. 18a contains a state diagrams illustrating the interactions between CPCS and MCD, according to some preferred embodiments; and

FIG. 18b contains a state diagrams illustrating the interactions between the MCD and the SCD, according to some preferred embodiments.

### DETAILED DESCRIPTION OF THE PREFERRED EMBODIMENTS

In preferred embodiments, the Master Client Device (MCD) 100 is entirely self-contained. The MCD 100 presents its programmed information via display devices 120, 121, and 122.

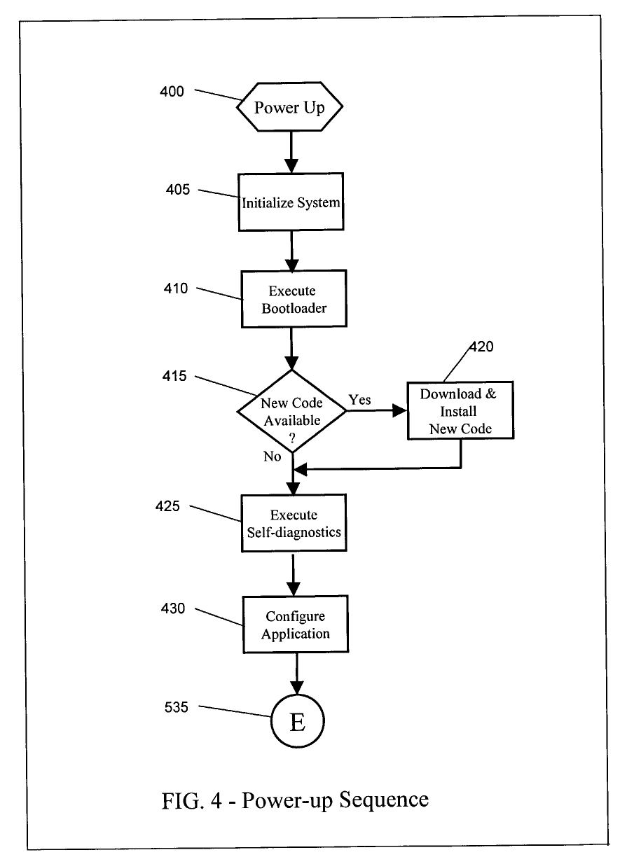

At the instant power is applied to MCD 100, Central Control Unit (CCU) 110 begins its internal power-up sequence 400, illustrated in FIG. 4. CCU 110 begins executing the program code with initializing the system at 405. The initialization places CCU 100 in a well-known state and transfers control to the bootloader 410. The purpose of the self-contained bootloader 410 is to listen to network 203 for possible update instructions from the CPCS 213. If such instructions are found 415, bootloader 410 reads the data supplied by CPCS 213 and self-programs CCU 110 accordingly 420. At the point of entering the self-diagnosis phase 425 of power-up sequence 400, CCU 110 executes a progression of diagnostic routines to determine the overall health of MCD 100. Abnormal conditions are transmitted over bus 203 back to CPCS 213 indicating a fault in a particular MCD 100. Upon a successful self-diagnosis 425, CCU 110 configures the main application 430 that then reads the minimum limit for display 120, the maximum limit for display 121 and/or the appropriate messages for display 122. A fully configured system transfers control to the main program loop 535.

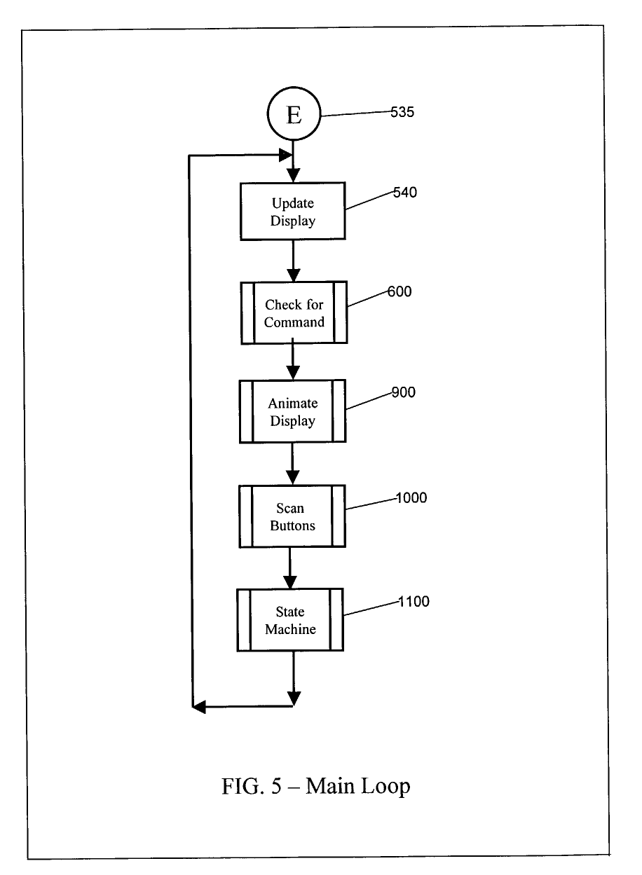

The main program loop begins at 535 in FIG. 5. The primary purpose of the loop is to constantly poll the main system components and respond accordingly system events. The main loop is organized in a priority order with the higher priority events being processed prior to lower priority events. To insure proper and smooth animation effects, CCU 110 first updates the displays 120, 121 and 122 at step 540.

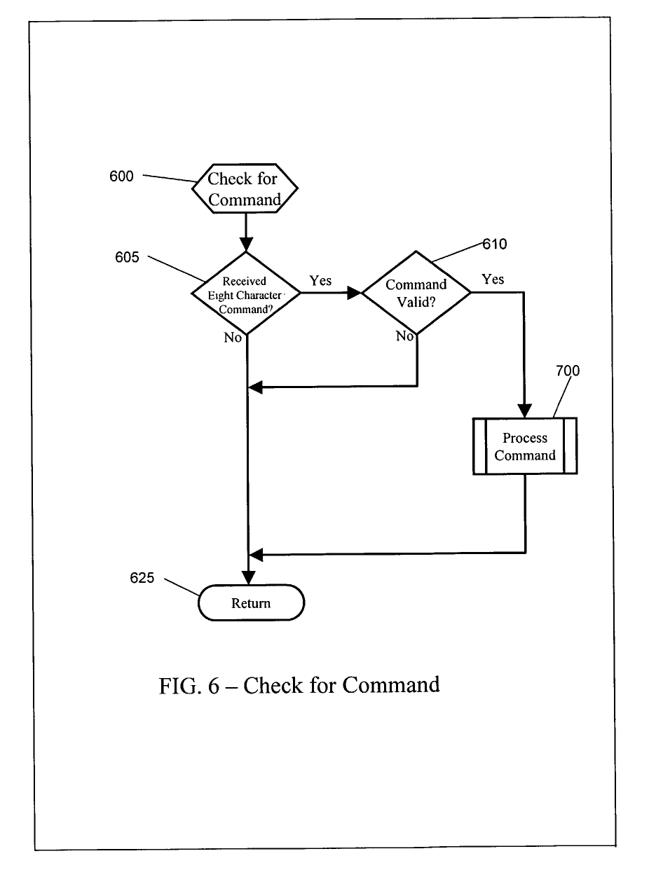

Block 600 illustrated by FIG. 6 begins the query of any pending commands. Commands received via network interfaces series 180 (185, 186, 187, 188) are processed by CCU 110. A complete command includes a sequence of characters. With each received character, block 605 checks to see if the full character sequence has been received. If enough characters have not been received, the Check for Command routine 600 returns via block 625. At the time the last character is received, block 610 validates the command by calculating a checksum of the previously received characters and comparing the result to the checksum byte (the last byte). If the command is not valid for whatever reason, the entire sequence of command characters is discarded and control returns through 625. When the command is validated, the control continues to Process Command 700.

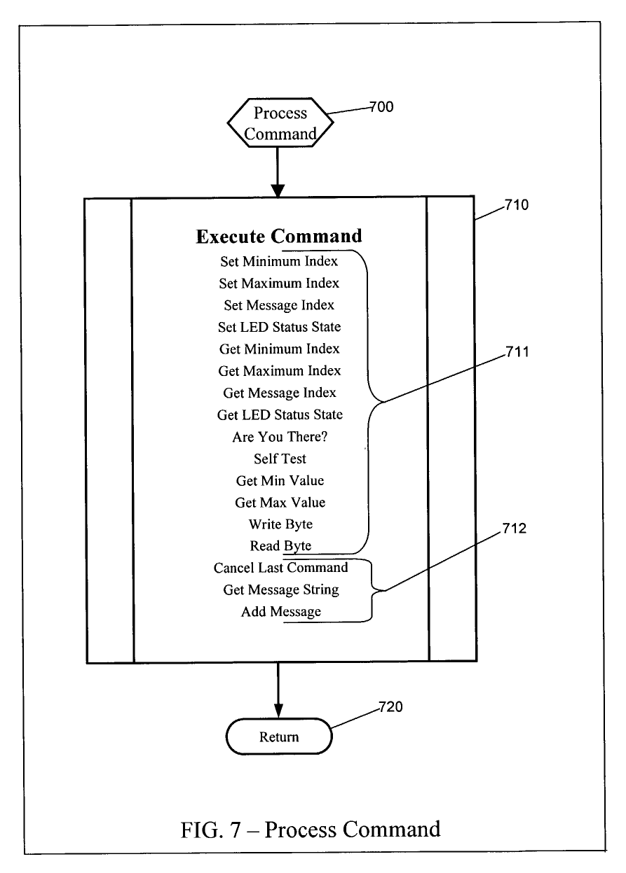

The function of processing the command 700, illustrated in FIG. 7, includes a plurality of command handlers 710. The command handlers interpret the received command and dispatch the appropriate code within CCU 110. Commands 710 are broken down into two categories, single segment commands 711 and multiple segment commands 712. Single segment commands 711 include commands with only a single-byte parameter and are processed as soon as received. Current single segment commands are cataloged 711 in FIG. 7. The smaller list of multiple segment commands 712 primarily relates to the setting, retrieving and cancellation of string messages. If any part of a multiple segment command 712 is found to be corrupt with an invalid checksum, determined in 610, then the entire command is automatically canceled. At the completion of either a single segment 711 or multiple segment 712 command, control continues by returning 720 to the main loop 535.

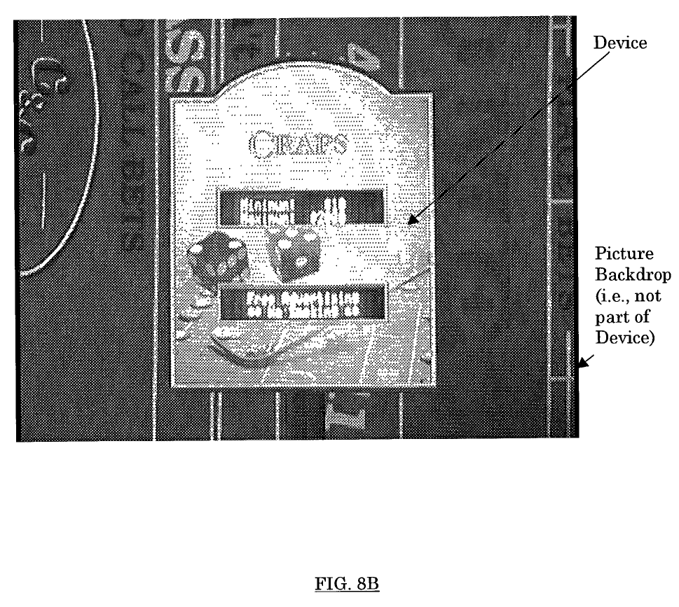

FIG. 9 illustrates an animation flow. Code originating at 900 insures that animation effects are smooth and are processed in a timely manner. CCU 110 initially retrieves the message descriptor 905 to determine the type 910 of animation effect to render. The message descriptor contains information required to precisely render the effect at the required speed and duration. Each of the plurality of animation effects 920, 921, 922, 923 and 924 configure the animation engine 930 to animate the characters of the current message appropriately. After the engine completes the animation effect, control returns through block 940.

The Flash Effect 920 includes alternating a single line of display 122 between visible characters and having said display blank, showing no characters. This alternation occurs, for example, at approximately twice each second in the preferred embodiment, however the rate is configurable to suite the individual casino's preferences.

The Scroll Effect 921 is like the typical marquee effect. The message is displayed passing by one line of display 122 as if said display line was a “window” into the entire length of the message. Such a “window” would be visible as moving across the message from the start of said message through to the end.

The Slide Effect 922 begins by placing the first character of the message into the leftmost position of display 122. Next, the second character of the message is placed into the second most left position of display 122. This process continues with the third character in the third most left position of display 122 and then continues until all characters of the message are visible on display 122.

The Walk Effect 923 is similar to the Slide Effect 922. In the preferred embodiment of 923, however, characters are scrolled from the right of display 122 to the left of the display, one character at a time, until the characters arrive in their final resting position of the display 122.

The Instant Effect 924 is straightforward in that the entire message appears on display 122 instantaneously, without any type of visible animation effect. The message remains on the display until removed.

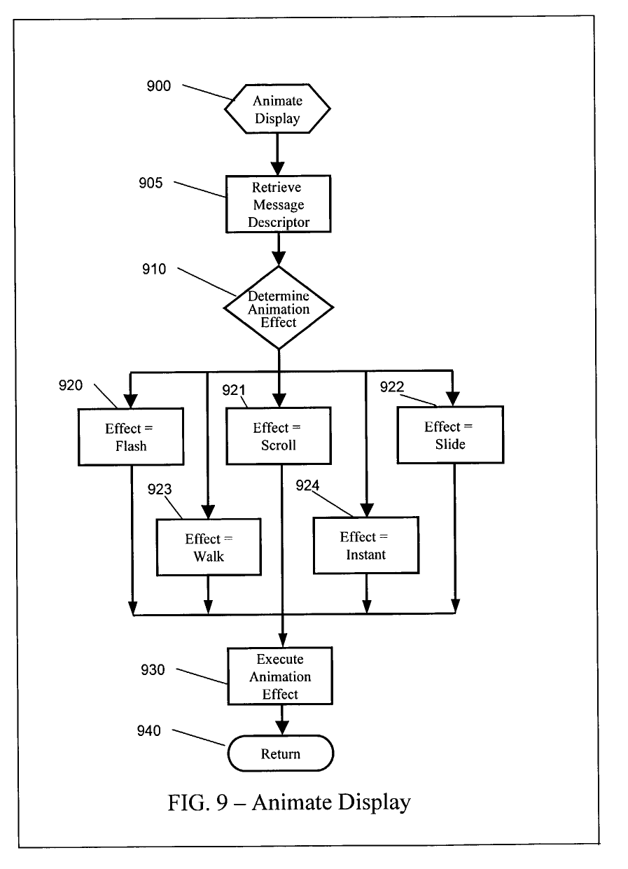

FIG. 10 illustrates the logic for determining the status of the buttons 147, 148, and 149. Control begins at 1000 where CCU 110 queries the status 1010 of said buttons. 1010 cleans up mechanical noise by debouncing the said buttons via software control. Various combinations of buttons are possible and the state of each button is stored in CCU 110 memory. Individual status of each of the buttons 147, 148 and 149 are made in order with 1020 determining the status for Button One 147, 1040 determining the status of Button Two 148, and 1050 determining the status for Button Three 149. If Button One 147 is depressed, a check is made for the simultaneous activation at 1023 of Button One 147 and Button Two 148. If both said buttons are depressed, then 1025 sets a flag indicating that both Button One and Button Two are simultaneously depressed. If, however, Button Two 148 is determined at 1023 not to be depressed, a flag is set indicating that only Button One is depressed 1030. If Button One 147 is not activated, but Button Two 148 is activated, a flag is set 1045 indicating said button is in a depressed state. If Button Three 149 is determined to be depressed 1050, the flag indicating such state is set at 1055. In all cases, subsequent to all buttons being tested and possibly some flags being set, control continues by returning at 1060 where FIG. 5 illustrates control continues with state machine 1100 taking control and acts according to the rules defined inside said machine.

In the background of CCU 110's main program loop is Interrupt Handler 1400. The handler's purpose is to record events occurring at exact, predetermined intervals, or events received via a network interface 180. Interrupt Handler 1400 begins by checking 1405 if data has been received by the serial network interface 180. If data has been received, said data is added to the receive buffer 1410. Control continues at 1415 to update the Large Clock Counter which is simply an area of memory inside CCU 110. The Large Clock Counter lengthens short intervals generated by the system interrupts. Such counter is used for buttons 147, 148 and 149 debounce timing and for controlling the animation rate of display 122. After said counters are updated, control returns from the interrupt 1420 back to the interrupted process.

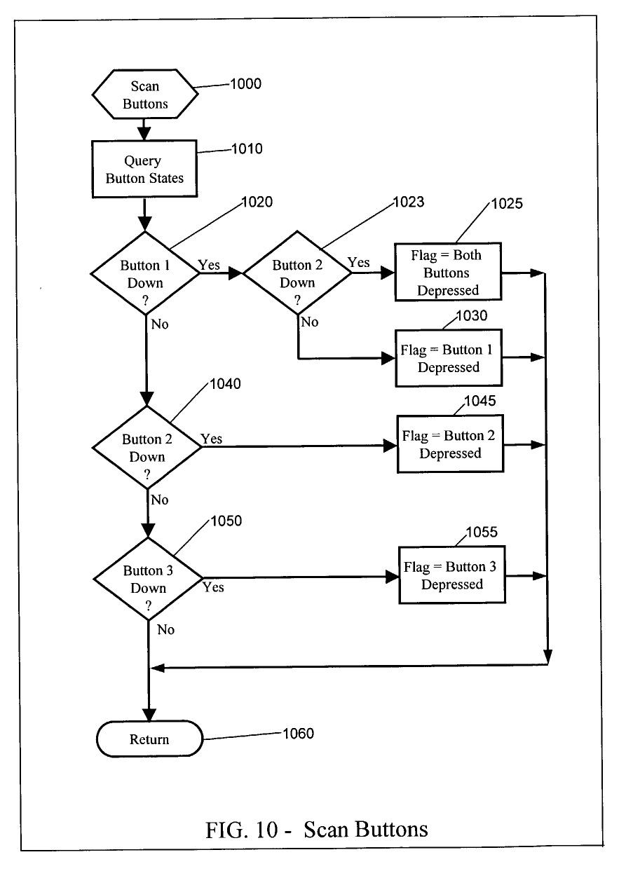

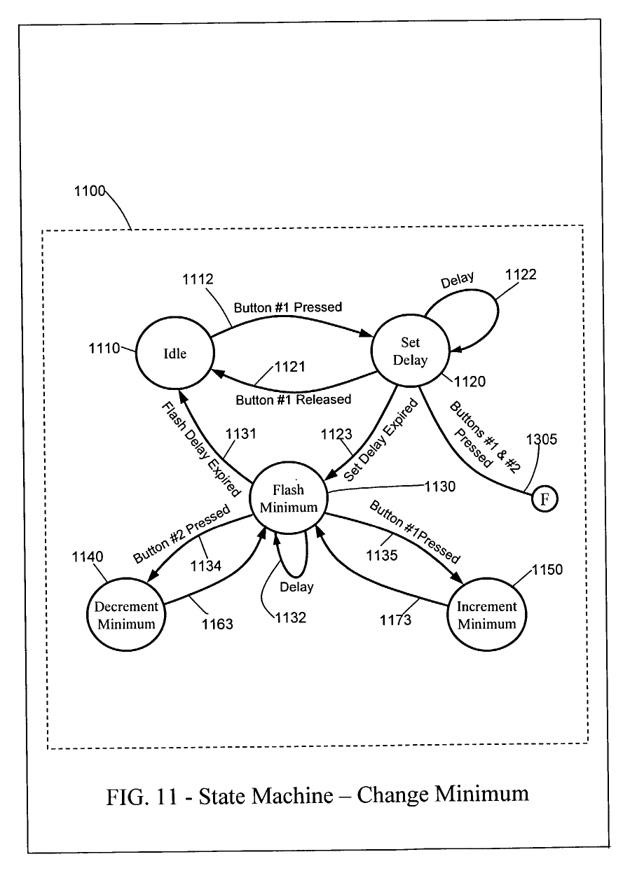

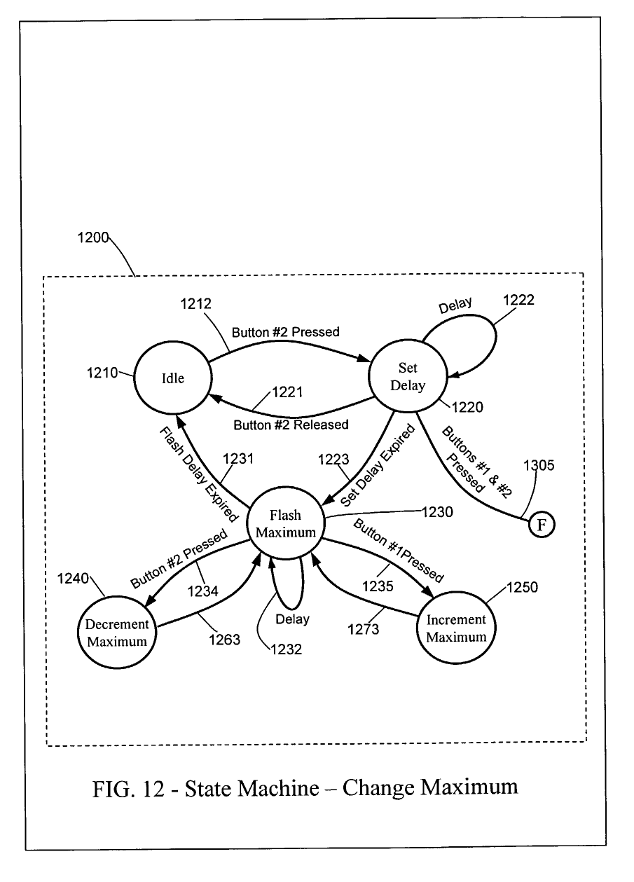

FIG. 11, FIG. 12, and FIG. 13 illustrate the plurality of states CCU 110 iterates through when responding to user input via button system 145. FIG. 11 illustrates the states realized during the process of changing the minimum limit. The rest state for state machine 1100 is Idle 1110. Upon pressing Button One 147 at 1112, CCU 110 enters a set delay period 1120. If Button One 147 is released before delay 1122 expires, the machine 1100 returns to the Idle state 1110 via path 1121. If, however, Button One 147 is held for period longer than delay 1122, allowing said delay to expire, machine 1100 enters the flash minimum state 1130 via path 1123. In the flash minimum state 1130, CCU 110 alternately turns the minimum display on and off resulting in a flashing effect. Such flashing effect indicates to the user that Button One 147 can be released and that the minimum limit 120 can be changed on the MCD 100. As long as Button One 147 or Button Two 148 is actuated before the flash delay 1132 expires, said buttons cause the state machine to increment and decrement the minimum limit 120. If, however, flash delay 1132 expires, state machine 1100 returns to the Idle state 1110 via event 1131. Actuating Button One 147 at 1135 instructs CCU 110 to enter state 1150 which resets the flash delay and increments the display 120 to the next higher minimum limit. The state machine then returns to the flash minimum state via path 1173, awaiting additional button actions. Actuating Button Two 148 at 1134 instructs CCU 110 to enter state 1140 which resets the flash delay and increments the display 120 to the next higher minimum limit. The state machine then returns to the flash minimum state via path 1163, awaiting additional button actions 147 and 148.

FIG. 12 illustrates the states realized during the process of changing the maximum limit 121. The rest state for state machine 1200 is Idle 1210. Upon pressing Button Two 148 at 1212, CCU 110 enters a set delay period 1220. If Button Two 148 is released before delay 1222 expires, the machine 1200 returns to the Idle state 1210 via event 1221. If, however, Button Two 148 is held for period longer than delay 1222, allowing said delay to expire 1223, machine 1200 enters the flash maximum state 1230. In the flash maximum state 1230, CCU 110 alternately turns the maximum display 121 on and off resulting in a flashing effect. Such flashing effect indicates to the user that Button Two 148 can be released and that the maximum limit 121 can be changed on the MCD 100. As long as Button One 147 or Button Two 148 is actuated before the flash delay 1232 expires, said buttons cause the state machine to increment and decrement the maximum limit 121. If, however, flash delay 1232 expires, state machine 1200 returns to the Idle state 1210 via event 1231. Actuating Button One 147 at 1235 instructs CCU 110 to enter state 1250 that resets the flash delay and increments display 121 to the next higher maximum limit. The state machine then returns to the flash maximum state 1230 via path 1273, awaiting additional button actions. Actuating Button Two 148 at 1234 instructs CCU 110 to enter state 1240 that resets the flash delay and increments display 121 to the next higher maximum limit. The state machine then returns to the flash maximum state 1230 via path 1263, awaiting additional button actions 147 and 148.

FIG. 13 illustrates the states realized during the process of changing the animated line of message 122. The rest state for state machine 1300 is Idle 1310. The state of Button One 147 and Button Two 148 existing simultaneously in the pressed position can occur from either of the Set Delay states in FIG. 11 1120 and FIG. 12 1220 and generates event 1305 which is the entry point for the Change Message state machine 1300. With both Button One 147 and Button Two 148 depressed, CCU 110 enters a set delay period 1320. If either of said buttons is released before delay 1322 expires, machine 1300 returns to the Idle state 1310 through paths 1312 or 1321. If, however, both buttons 147 and 148 are held for a period longer than delay 1322, allowing said delay to expire, machine 1300 enters the flash message state 1330 via event 1323. In the flash message state 1330, CCU 110 alternately turns the animated message line of display 122 on and off resulting in a flashing effect. Such flashing effect indicates to the user that both buttons 147 and 148 can be released and that the active message 122 can be changed on the MCD 100. As long as either Button One 147 or Button Two 148 is actuated before the flash delay 1332 expires, said buttons cause the state machine 1300 to flash the next or previous message on the animated line of display 122. If, however, flash delay 1332 expires, state machine 1300 returns to the Idle state 1310 via event 1331. Actuating Button One 147 at 1335 instructs CCU 110 to enter state 1350 that resets the flash delay and increments display 122 to the next available message. The state machine then returns to the flash message state 1330 via event 1373, awaiting additional button actions. Actuating Button Two 148 at 1334 instructs CCU 100 to enter state 1340 that resets the flash delay 1332 and decrements display 122 to the previously available message. The state machine then returns to the flash message state 1330 via event 1363, awaiting additional button actions 147 and 148.

It should be apparent to those in the art, based on this disclosure, that the foregoing description is of an illustrative preferred embodiment and that various modifications can be made in other embodiments of the invention.

Satellite Client Device:

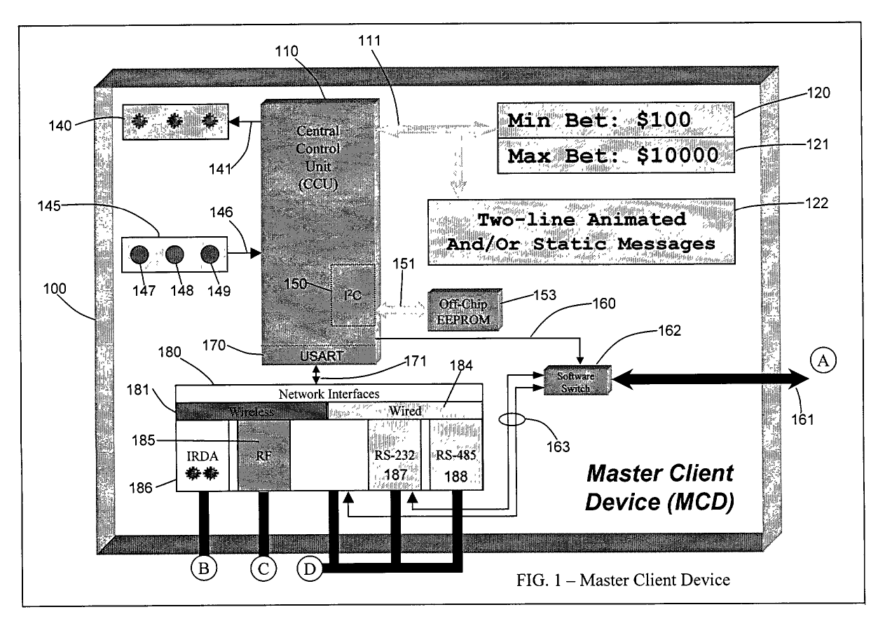

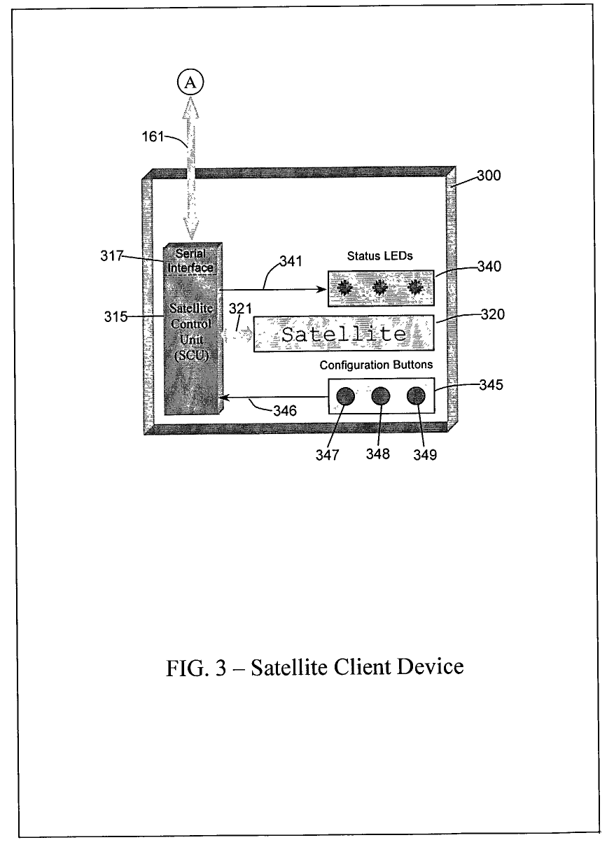

FIG. 3 illustrates a block diagram of the Satellite Client Device (SCD) 300. Satellite Client Device 300 enables control of MCD 100 in a remote fashion. Satellite Control Unit (SCU) 315 sends and receives commands over bi-directional bus 161 while passing through bi-directional buffer 310. FIG. 1 depicts the physical communications between MCD 100 and SCD 300.

SCD 300 can be similar to, but simpler than MCD 100. SCD 300 communicates to MCD 100 via communications path 161. SCU 315 contains serial interface 317 that interprets messages on communications path 161. Interface 317 also transmits the communications back to MCD 100

SCD 300 contains input and output devices as does the Master Client Device. SCU 315, processing commands from MCD 100, can send the appropriate signals along path 341 to illuminate or darken Status LEDs 340.

Also under the MCDs control, SCU 315 manipulates signal bus 321 to instruct Display Unit 320 to present the indicated textual message.

Users may indicate casino-specific statuses back to the MCD via Button System 345. In its preferred embodiment, Button System 345 includes up to three buttons 347, 348 and 349. Each of these buttons can be defined, buy the casino operators, to indicate that specific events are occurring at a particular gaming table. One such use could be to press one of buttons 347, 348 or 349 the number of times that represents the current count of players at any given table.

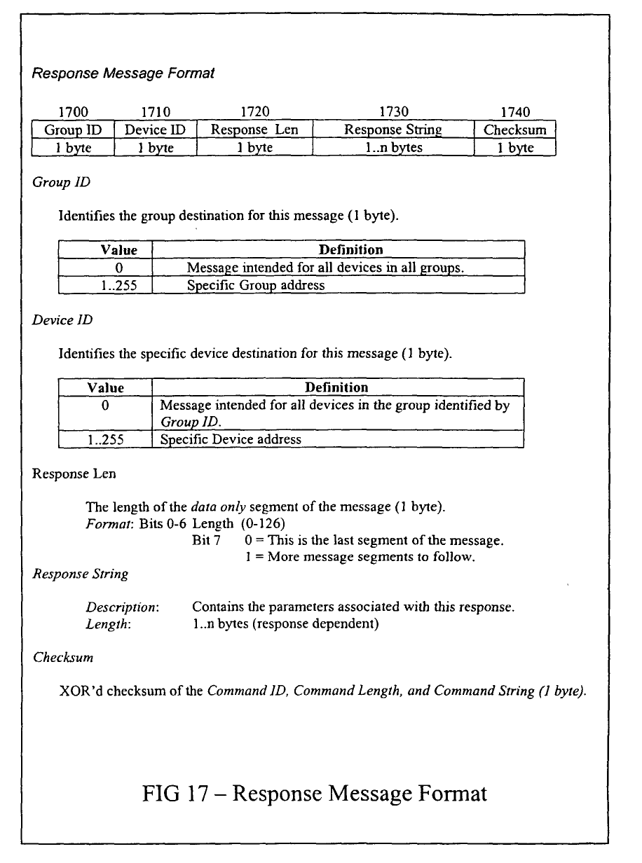

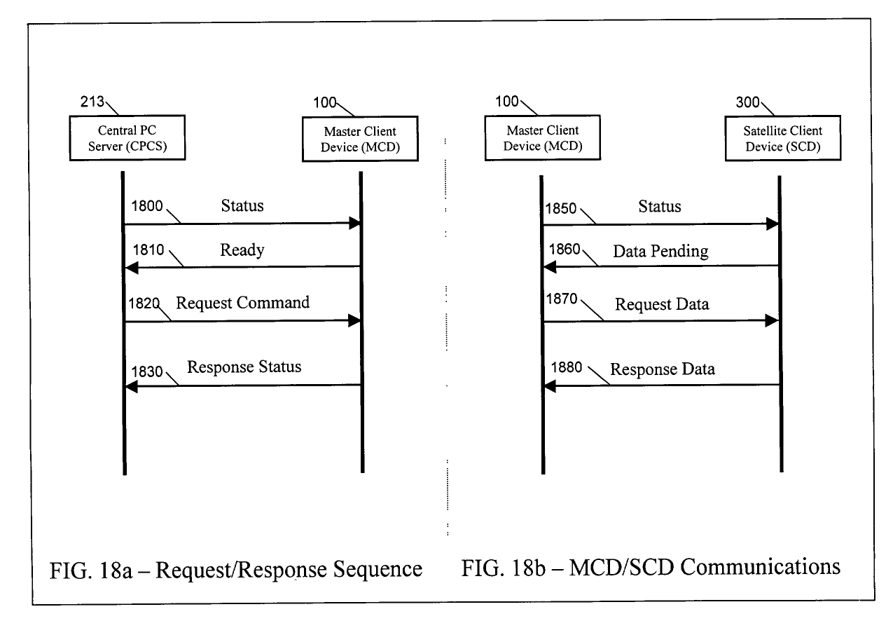

FIG. 18b shows state diagrams illustrating the interactions between MCD 100 and SCD 300. The communications protocol is a simple request/response protocol. MCD 100 begins by requesting the status 1850 of SCD 300. Said SCD responds with a Data Pending 1860 message. If the content of the message indicates that data is truly pending, MCD 100 sends a Request Data 1870 message to SCD 300. At this point, SCD 300 packages the requested data into a Response Data 1880 message and sends said message back to MCD 100.

It should be apparent to those in the art, based on this disclosure, that the foregoing description is of an illustrative and non-limiting embodiment and that various modifications can be made in other embodiments.

Network:

FIG. 18a illustrates state diagrams illustrating the interactions between Central PC Server (CPCS) 213 and Master Client Device (MCD) 100. The communications protocol is a simple request/response protocol. CPCS 213 begins by requesting the status 1800 of MCD 100. The MCD responds with a Ready 1810 message. If the content of the message indicates that MCD 100 is truly ready, CPCS 213 sends a Request Command 1820 message to MCD 100. At this point, MCD 100 packages the requested data into a Response Status 1830 message and sends the message back to CPCS 213.

Internal to CCU 110 exists a Universal Synchronous Asynchronous Receiver Transmitter (USART) 170. USART 170 communicates via bus 171 with network interface 180 via the wired interface 184 along mediums 187 and 188. CCU 110 communicates via bus 171 with network interface 180 via wireless interface 181 along mediums 185 and 186.

The preferred embodiment of medium 203 is a hard-wired local area network. However, in other embodiments, any other network could be employed, such as a wide area network (WAN), the Internet, a virtual private network (VPN) or other networks. MCD 100 communicates with medium 203 via a plurality of interfaces identifying various network protocols, such as, for example, in preferred embodiments RS-232 187 and RS-485 188.

CCU 110's ability to communicate with satellite device 300 is realized through hardwired RS-232 187 or RS-485 188 communications. Communications protocols 187 or 188 are routed through signal 163 to the satellite device 300 via software switch 162.

Wireless medium RF 202 is the basis for communication between MCD 100 and CPCS 213. Multi-channel RF transceiver 212 encodes and decodes messages to and from the CPCS over RF medium 202.

Hardwired network protocol along bus 203 has an ultimate source and destination of CPCS 213. CPCS 213 operates any of a plurality of commercial operating systems and executes resident program 220 customized to each establishment. Program 220 administers messages destined for a multitude of MCD 100 devices. Message protocol is illustrated in FIG. 18a.

For standalone MCD 100 systems, button system 145 provides the user interface to manipulate the settings for the MCD 100. In addition to button system 145, standalone MCD 100 sends and receives commands via wireless IrDA medium 201 to and from IrDA device 211. IrDA device 211 formats commands CCU 110 interprets as described in FIG. 18a.

It should be apparent to those in the art, based on this disclosure, that the foregoing description is of an illustrative and non-limiting embodiment and that various modifications can be made in other embodiments.

Messages:

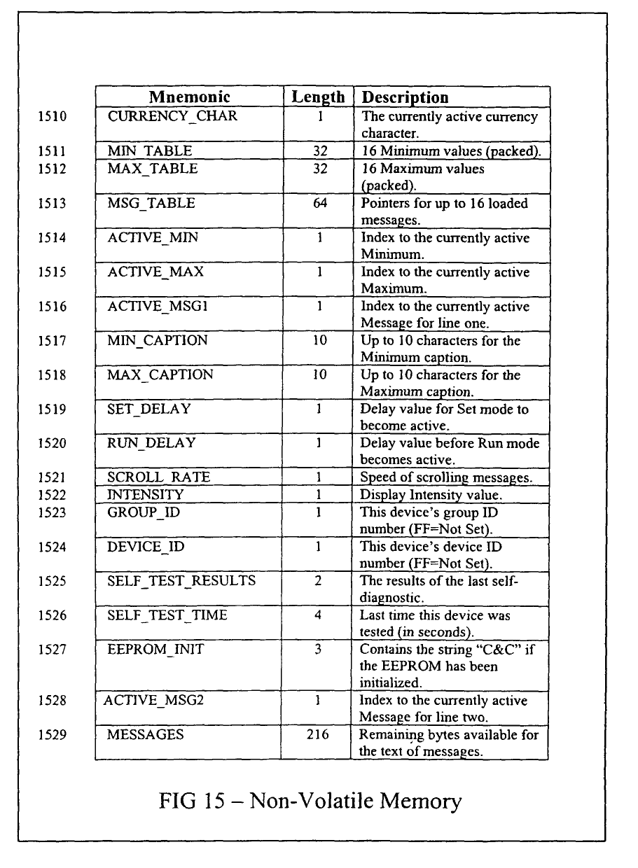

A message includes of a plurality of segments designed to signify various types of information. Request messages, those messages originating from CPCS 213, are preferably formatted as described in FIG. 16. Bytes one 1600 and two 1610 describe the destination MCD 100 system for where the message is destined. Byte one 1600 is the group indicator (Group ID) and corresponds to a plurality of similar devices arranged within a common area. Addressing a message to a specific Group ID instructs all MCD 100 devices with the group to interpret the message. A Group ID of zero (0) instructs all groups to interpret said message. Byte two 1610 references a specific device within the aforementioned group. Addressing a message to a specific device instructs the MCD 100 device with a matching device identifier (Device ID) to interpret the message. A Device ID of zero (0) instructs all devices within the associated group to interpret the message. For example, all MCD 100 devices assigned to group five will be acted upon by a message with Group ID five and Device ID zero. In another example, all MCD 100 devices attached to the network 203 will be acted upon by messages with Group ID zero and Device ID zero.

The Command ID 1620 is the function code number relating back to the commands listed in FIG. 7 at 710. The Command Length 1630 is the length, in bytes, of the command. The actual Command String 1640 may be one to many bytes in length. The content of Command String 1640 varies depending on the actual Command ID 1620.

A checksum is derived prior to completing the transmission of a message. The checksum value is transmitted in the Checksum Byte 1650. The receiver of the message will compare its private derived checksum with the checksum received and reject the message if the checksums do not match.

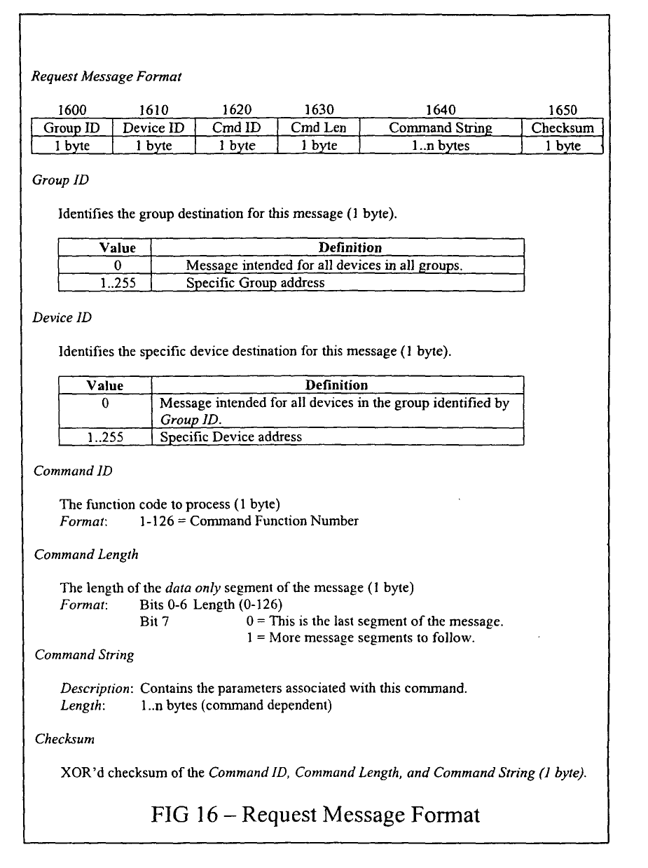

Response Messages, described in FIG. 17, are simpler than, but just as notable as the Request Messages. The Response Message also begins with Group ID 1700 and Device ID 1710. Device ID 1710 is followed by the length of response message 1720. As in the Request Message, the Response String 1730 is required. The Response String 1730 may be one to many bytes in length. The content of the Response String 1730 varies depending on the actual Command ID 1620 received.

A checksum is also derived for Response String 1730 prior to completing the response to a message. The checksum value is transmitted in the Checksum Byte 1740. The original sender of the message will compare its private derived checksum with the checksum received and reject the response if the checksums do not match.

Software:

The preferred settings 1510-1522, FIG. 17, from onboard memory 153 are requested by CCU 110, through the Intra-Integrated Circuit (I²C) subsystem 150, and the settings are returned to CCU 110 via bus 151, through I²C subsystem 150 and into the CCU 110 local memory.

CCU 110 interprets the settings 1510-1522 and writes the appropriate values to bus 111. Displays 120, 121 and 122 receives the data and presents it appropriately.

Non-Volatile Memory Layout:

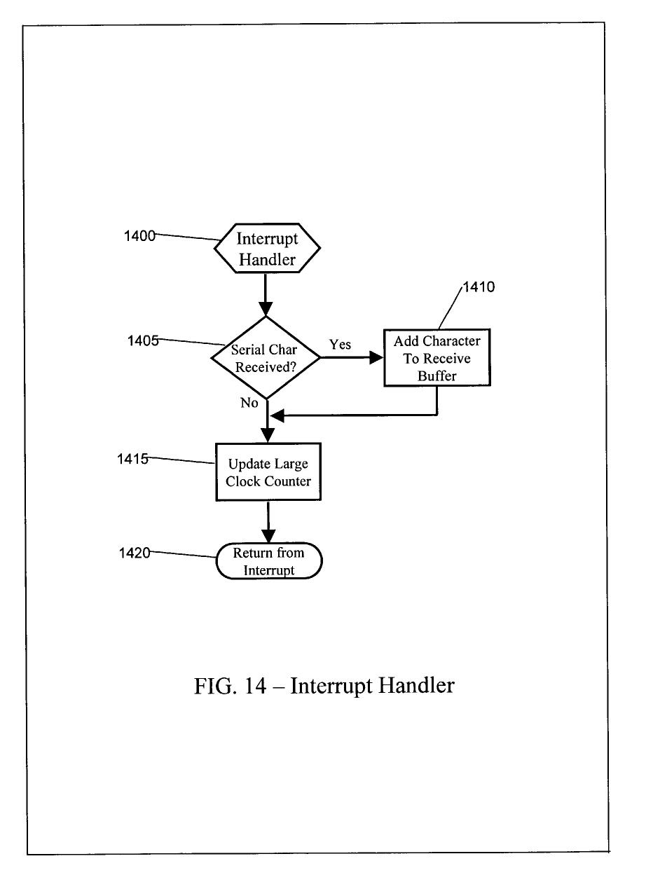

FIG. 15 tabulates the preferred embodiment of persistent memory in the onboard non-volatile memory of CCU 110. 1510 contains the currency symbol. Symbol 1510 is used for the minimum limit 120 and maximum limit 121 displays and is customizable based on the type of currency in the casino. The Minimum Table 1511 and the Maximum Table 1512 each hold a plurality of minimum and maximum values, respectively. The values stored in 1511 and 1512 allow CCU 110 to render a minimum limit from 1511 to minimum display 120, and to render a maximum limit from 1512 to maximum display 121. 1513 holds the set of pointers to stored messages. One preferred embodiment is to store messages in non-volatile memory, while another preferred embodiment is to store messages in off-chip memory 153. Table 1513 determines where in memory each message is stored. 1514 indicates the currently active minimum index into table 1511. 1515 indicates the currently active maximum index into table 1512. 1516 indicates the line one of the currently active message into table 1513. And, 1528 indicates line 2 of the currently active message into table 1513. In addition to rendering the minimum and maximum limits, the minimum limit 120 and maximum limit 121 displays each display a minimum caption 1517 and a maximum caption 1518 for each limit. For example, a casino may choose to identify the minimum limit by displaying “Min Bet:” in front of the dollar amount of display 120.

Delay 1519 is used in determining how long 1322 either of Button One 147 or Button Two 148 must be held for before entering the flash states 1130, 1230, or 1330. Delay 1520 determines how long before the flash delays 1132, 1232, and 1332 expire.

Value 1521 controls the animated scroll rate. Value 1522 determines the overall brightness of displays 120, 121, and 122.

Values 1523 and 1524 determine the identity of the specific MCD 100. 1523 is the group identifier while 1524 is the individual identifier. The Messages section describes the interactions of group identifier 1523 and individual identifier 1524.

Value 1525 holds the results of the last self-test and Value 1526 holds the time of the last self-test. Values 1525 and 1526 can be queried to determine the overall health of MCD 100.

Value 1527 is checked during the Configure Application 430 step. If the values beginning at 1527 contain the three identification characters, then MCD 100 has been initialized. Any other values instruct CCU 110 to re-configure the application.

The memory beginning at 1529 is a free block used to hold text messages eventually to be animated on display 122.

Further Embodiments:

In various other embodiments, one or more aspect of the invention may be employed in other environments and/or for purposes outside of casinos and/or gaming establishments. For example, in some illustrative embodiments, aspects of the invention may be employed in a commercial establishment in which various goods and/or services are marketed to consumers. For instance, one or more Master Client Device can be located at predetermined positions within such an establishment (e.g., proximate where certain goods and/or services are displayed, sold or the like). For instance, in a department store having a plurality of isles of display-shelving, a Master Client Device can be located, for instance, proximate a front side of a plurality or all of such isles. In some illustrative embodiments, the Master Client Device can be used to display one or more of: prices for one or more goods or services marketed; sales information related to one or more goods or services marketed; promotional and/or advertisement information related to one or more goods or services offered; promotional and/or advertisement information related to that particular commercial establishment or related to other items or entities; and/or any other desired information that may be useful for display (e.g., lost-and-found persons or products information, fact trivia information, and/or assorted other information). In preferred embodiments, the information displayed, such as price information, sales information and/or other information, can be managed and/or changed in a manner similar to that of any of the embodiments described herein-above. For example, in some embodiments, information may be altered and/or modified by a roaming administrator, such as a store manager or the like, who can walk through the store and change the information displayed via, most preferably, a handheld remote device. As another example, in some embodiments, this information may be altered and/or modified by entry at a Central Server, such as by a manager, that can be in some illustrative embodiments located outside of the customer product and/or service display area, such as in a remote office location. As a result, various embodiments of the invention can have great utility in casinos or gaming institutions and/or in various other commercial establishments.

Broad Scope of Invention:

While illustrative embodiments of the invention have been described herein, it will be appreciated that the present invention is not limited to the various embodiments described herein, but includes any and all embodiments having modifications, omissions, combinations (e.g., of aspects across various embodiments), adaptations and/or alterations as would be appreciated by those in the art based on the present disclosure. The appended claims are to be interpreted broadly based the language employed in the claims and not improperly limited to illustrative examples described in the present specification or in the prosecution of the application. As merely one example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts are not recited in support of that function.

What is claimed is:

1. A method of presenting gaming information to at least one casino gaming player at a gaming table, comprising:
a) providing a casino gaming table;
b) locating a client device proximate said at least one table;
c) inputting gaming information into said client device; and
d) displaying at least some of the gaming information via a display connected to said client device.

2. The method of claim 1, wherein said inputting gaming information includes inputting said information via a user input connected to said client device.

3. The method of claim 1, wherein said inputting gaming information includes inputting said information via a central server.

4. The method of claim 3, wherein said client device is connected via a computer network to said central server.

5. The method of claim 4, wherein a plurality of additional client devices are connected via the computer network to said central server, each of said client devices being located proximate respective tables.

6. The method of claim 1, wherein said inputting gaming information includes inputting said information via a handheld device.

7. The method of claim 5, wherein said handheld device has a remote interface that can remotely communicate with said client device.

8. The method of claim 6, wherein said remote interface transits signals wirelessly to said client device.

9. The method of claim 5, wherein said handheld device is manipulated by a roaming administrator that operates a plurality of such client devices with said handheld device.

10. The method of claim 1, wherein said information includes betting information.

11. The method of claim 10, wherein said information includes allowed betting amounts.

12. The method of claim 11, wherein said information includes a minimum bet amount.

13. The method of claim 11, wherein said information includes a maximum bet amount.

14. The method of claim 1, wherein said information includes informational messages communicated to the at least one player.

15. The method of claim 14, wherein said informational messages include table reserved status, table open status or table closed status.

16. The method of claim 14, wherein said informational messages include promotional information.

17. The method of claim 14, wherein said informational messages include smoking status of the table.

18. The method of claim 14, wherein said informational messages are delivered to said client device via a central server having a user input.

19. The method of claim 14, further including displaying said informational messages with alphanumeric characters.

20. The method of claim 14, further including displaying said informational messages with sequences of displayed images.

21. The method of claim 20, further including creating an animated display with said sequences of images.

22. The method of claim 1, further including providing a plurality of client devices which are connected via a network to a central server, each of said client devices being located proximate respective gaming tables.

23. The method of claim 22, wherein said central server synchronizes the client devices.

24. The method of claim 22, wherein said central server receives table information from said client devices.

25. The method of claim 1, wherein a casino manager sets bet amounts via an input device in communication with the client device.

26. The method of claim 25, wherein the bet amounts inputted are relayed to a central server via a computer network.

27. The method of claim 22, further including having a central manager send an alert to a gaming manager via an input connected to the central server to send alert information for display on at least one of said client devices.

28. A casino computer system, comprising:
a) at least one gaming table;
b) at least one client device proximate said gaming table;
c) at least one input device for inputting gaming information into said client device; and
d) a display device for displaying said gaming information to gaming players.

29. The casino computer system of claim 28, wherein said input device includes a user input for inputting gaming information for said client device.

30. The casino computer system of claim 28, wherein said input device includes a handheld device.

31. The casino computer system of claim 28, wherein said handheld device includes a remote interface that wirelessly communicates with said client device.

32. The casino computer system of claim 28, wherein said input device inputs information to a central server that communicates said information to said client device via a communications network.

33. The casino computer system of claim 29, wherein said input device has a manual user interface.

34. The casino computer system of claim 33, wherein said input device includes a plurality of finger operable buttons.

35. The casino computer system of claim 29, wherein said input device is remote from said client device.

36. The casino computer system of claim 35, wherein said input device is a wired remote device.

37. The casino computer system of claim 35, wherein said input device is a wireless remote device.

38. The casino computer system of claim 28, wherein said client device includes a plurality of input/output control interfaces.

39. The casino computer system of claim 38, wherein said plurality of input/output control interfaces uses at least one of: a serial communications protocol and a TCP/IP protocol.

40. The casino computer system of claim 28, wherein said at least one gaming table is configured for games using minimum or maximum bets and said gaming information includes alphanumeric representations of said minimum or maximum bet amounts.

41. The casino computer system of claim 40, wherein said at least one gaming table includes a black jack table.

42. The casino computer system of claim 40, wherein said at least one gaming table includes a roulette table.

43. The casino computer system of claim 40, wherein said at least one gaming table includes a table configured for a game of chance, including cards or dice.

44. The casino computer system of claim 38, wherein said plurality of input/output control interfaces includes at least one of: an IRDA interface and an RF interface.

45. A gaming computer system, comprising:
a) a plurality of client devices including respective displays;
b) said displays of said client devices being located proximate respective gaming tables; and
c) at least one user-interface for inputting information that is displayed on said displays.

46. The gaming computer system of claim 45, wherein said user-interfaces are respectively located for manual control by game managers at said respective tables.

47. The gaming computer system of claim 45, wherein said user-interfaces include an interface that enables an administrator to control a plurality of such client devices at a respective plurality of tables.

48. A process for producing a gaming-system product including a gaming information display proximate a gaming table, comprising:
a) providing a gaming table;
b) locating a client device proximate said table;
c) inputting gaming information into said client device; and
d) displaying at least some of the gaming information via a display connected to said client device, further including displaying as part of said gaming information minimum or maximum table bets and promotional information.

49. The process of claim 44, further including displaying moving or animated images as part of said gaming information.

50. A method of presenting product or service information to customers of a casino or other commercial establishment, comprising:
a) marketing products or services to customers at a plurality of discrete locations within a commercial establishment;
b) locating client devices proximate a plurality of said plurality of locations, each of said client devices being located proximate respective said locations;
c) inputting product or service information into said client devices;
d) displaying at least some of the product or service information via displays connected to said client devices;
e) wherein said inputting information includes inputting information via a central server, wherein said client devices are connected via a computer network to said central server;
f) wherein said inputting information further includes inputting said information via a handheld device, wherein said handheld device has a remote interface that can remotely communicate with said client device, wherein said remote interface transits signals wirelessly to said client device;
g) wherein said handheld device is manipulated by a roaming administrator that operates a plurality of such client devices with said handheld device.
